(19) United States
(12) Patent Application Publication
(10) Pub. No.: US 2016/0109742 A1
(43) Pub. Date: Apr. 21, 2016

(54) LIQUID CRYSTAL DISPLAY

(71) Applicant: SHENZHEN CHINA STAR OPTOELECTRONICS TECHNOLOGY CO., LTD.,, Shenzhen, Guangdong (CN)

(72) Inventor: Xiaohui YAO, Shenzhen (CN)

(21) Appl. No.: 14/416,905

(22) PCT Filed: Dec. 15, 2014
(86) PCT No.: PCT/CN2014/093886

§ 371 Date: Jan. 23, 2015

(30) Foreign Application Priority Data
Oct. 17, 2014 (CN) 201410554914.2

(51) Int. Cl. G02F 1/1339; G02F 1/1335; G02F 1/1362

(52) U.S. Cl. CPC G02F 1/13394; G02F 1/136286; G02F 1/133514; G02F 1/133512

(57) ABSTRACT

A liquid crystal display is provided, comprising a cell body which includes a first substrate and an opposite second substrate and is used for accommodating liquid crystals. An area of the cell body which accommodates liquid crystals forms a display area, and a periphery of the display area forms an assembly area. In the display area, the second substrate has a surface which faces the first substrate and is provided with a convex gate line region and a convex data line region, and the first substrate has a surface which faces the second substrate and is provided with a first recess that can be matched with the gate line region and the data line region. When the first substrate and the second substrate are fit together, both of the gate line region and the data line region are engaged with the first recess to form a first nest portion, so as to prevent relative movement between the first substrate and the second substrate.

### CROSS-REFERENCE TO RELATED APPLICATIONS

The present application claims benefit of Chinese patent application CN 201410554914.2, entitled “Liquid crystal display” and filed on Oct. 17, 2014, the entirety of which is incorporated herein by reference.

### FIELD OF THE INVENTION

The present disclosure relates to the field of flat panel displays, and in particular, to a liquid crystal display.

### BACKGROUND OF THE INVENTION

Liquid crystal displays (LCDs for short) constitute the mainstream displays currently. An LCD is generally provided with two glass substrates therein which form a cell. The cell is filled with liquid crystals. An electric field is formed through a circuit provided on the glass substrate to control rotation of the liquid crystals. The electric field also determines whether backlight will pass through the liquid crystal cell for display of images.

The two glass substrates of a liquid crystal cell each usually comprise an upper color filter substrate and a lower array substrate. The color filter substrate includes a color barrier layer (RGB), a black matrix (BM), a post spacer (PS), and a common electrode (ITO), while the array substrate is provided with a circuit therein for control of pixels.

The upper substrate and the lower substrate would be easily dislocated with respect to each other under impact after they fit together, thereby reducing yield of the liquid crystal display.

### SUMMARY OF THE INVENTION

To solve the above problem, the present disclosure provides a liquid crystal display. An upper substrate of the liquid crystal display and a lower substrate thereof can be engaged with each other through a nested structure, so as to prevent dislocation between the upper and lower substrates.

1) According to the present disclosure, a liquid crystal display is provided, comprising a cell body which includes a first substrate and an opposite second substrate and is used for accommodating liquid crystals, an area of the cell body which accommodates liquid crystals forming a display area, and a periphery of the display area forming an assembly area. In the display area, the second substrate has a surface which faces the first substrate and is provided with a convex gate line region and a convex data line region, and the first substrate has a surface which faces the second substrate and is provided with a first recess that can be matched with the gate line region and the data line region. When the first substrate and the second substrate fit together, the gate line region and the data line region engage with the first recess to form a first nest portion, so as to prevent relative movement between the first substrate and the second substrate.

In the liquid crystal display according to the present disclosure, the first nest portion can be arranged to effectively prevent relative movement between the first substrate and the second substrate, thus improving yield of the liquid crystal display. In addition, since an existing liquid crystal display already has a convex gate line region and a convex data line region, it is only necessary to further provide the first recess on the first substrate, instead of redesigning a first nested structure on the first substrate and the second substrate, which reduces influences imposed upon aperture ratio of a pixel and meanwhile decreases production costs of the liquid crystal display.

2) In one embodiment according to item 1) of the present disclosure, the gate line region and the data line region intersect with each other, and the first recess is provided at an intersection of the gate line region and the data line region and can be matched with a shape of the intersection. The gate line region and the data line region in an intersected arrangement and the first recess can stop relative movement between the first substrate and the second substrate both horizontally and longitudinally, thereby further improving yield of the liquid crystal display. In addition, in an existing liquid crystal display, the gate line region and the data line region have already form an intersection shape, such as a cross. The first recess can be arranged at the intersection, so that the gate line region and the data line region will not be necessarily configured as intersecting with each other, thus reducing both design difficulty and production costs.

3) In one embodiment according to item 1) or 2) of the present disclosure, the first substrate is in the form of a color filter substrate and the second substrate is in the form of an array substrate, wherein the gate line region comprises a gate line and a gate line protective layer covering the gate line, and the data line region comprises a data line and a data line protective layer covering the data line. The gate line region has a projection height that can be adjusted through adjustment of thickness of the gate line and that of the gate line protective layer, and the data line region has a projection height that can be adjusted through adjustment of thickness of the data line and that of the data line protective layer. As such, corresponding convex gate line region and convex data line region can be formed according to specific conditions of the first substrate and the second substrate.

4) In one embodiment according to item 3) of the present disclosure, the first recess is provided in a spacer or a color barrier layer of the color filter substrate.

5) In one embodiment according to item 3) or 4) of the present disclosure, the array substrate is provided with a pixel electrode thereon, and the color filter substrate is provided with a black matrix that covers a part of the pixel electrode and forms a coverage region thereon. An interval formed between the gate line region and a side wall of the first recess has a smaller size than the coverage region, and an interval formed between the data line region and a side wall of the first recess has a smaller size than the coverage region also. With such arrangement, even there would be a small relative movement between the first substrate and the second substrate due to an assembly interval between the gate line region and the data line region in the first recess, the black matrix would still cover the pixel electrode. As a result, the black matrix would not be subject to inadequate shading, nor would it be subject to the problem of light leakage at an edge thereof in a dark state, whereby quality of the liquid crystal display can be improved.

6) In one embodiment according to any one of items 1) or 5) of the present disclosure, in the assembly area, one of the first substrate and the second substrate is provided with a convex structure, and the other of the first substrate and the second substrate is provided with a second recess that can be matched with the convex structure. When the first substrate and the second substrate fit together, the convex structure and the second recess engage with each other to form a second nest portion, so as to prevent relative movement between the first substrate and the second substrate.

The second nest portion can assist the first nest portion to further prevent relative movement between the first substrate and the second substrate, so as to improve yield of the liquid crystal display.

7) In one embodiment according to item 6) of the present disclosure, the convex structure has a size smaller than the second recess. Thus, even if the first substrate and/or the second substrate may somehow bend, the wider second recess can still compensate assembly of the convex structure so as to facilitate the assembly thereof.

8) In one embodiment according to item 6) or 7) of the present disclosure, the convex structure is in the shape of a cross, a strip, a circle, or the letter T, and the second recess can be matched with the convex structure in shape. In one preferred embodiment, the convex structure is in the form of a cross, and the second recess can be matched with the convex structure.

9) In one embodiment according to any one of items 6) to 8) of the present disclosure, the first substrate is in the form of a color filter substrate and the second substrate is in the form of an array substrate. The convex structure comprises a metal layer and a metal protective layer that covers the metal layer, and has a projection height that can be adjusted through adjustment of thickness of the metal layer and that of the metal protective layer. As such, a corresponding convex structure can be formed according to specific conditions of the first substrate and the second substrate.

10) In one embodiment according to item 9) of the present disclosure, the second recess is provided in the spacer or in the color barrier layer of the color filter substrate.

Compared with the prior art, the present disclosure can bring about the following advantages. To start with, a first nest portion arranged in the display area and a second nest portion arranged in the assembly area of a cell body can effectively prevent relative movement between the first substrate and the second substrate, thus improving yield of the liquid crystal display. Besides, since an existing liquid crystal display already has a convex gate line region and a convex data line region, it merely necessary to additionally arrange a first recess on the first substrate, thereby reducing influences imposed upon the aperture ratio of a pixel and decreasing production costs of the liquid crystal display. Moreover, a side of the first substrate remote from the second substrate is provided with a black matrix, in a region of which the first recess is located. Such black matrix can completely cover the first recess, and would not be subject to inadequate shading, nor would it be subject to the problem of light leakage at an edge thereof in a dark state, thereby improving quality of the liquid crystal display.

### BRIEF DESCRIPTION OF THE DRAWINGS

In the following, the present disclosure will be illustrated in detail in connection with embodiments and accompanying drawings, in which:

FIG. 1 is a front view of a cell body of a liquid crystal display according to the present disclosure;

FIG. 2 schematically shows the structure of a first nest portion according to the present disclosure;

FIG. 3 is a cross-section view of FIG. 2 along line A-A;

FIG. 4 is a cross-section view of FIG. 2 along line B-B;

FIG. 5 shows a first assembly mode according to the first nest portion of the present disclosure;

FIG. 6 shows a second assembly mode according to the first nest portion of the present disclosure;

FIG. 7 schematically shows the structure of a second nest portion according to the present disclosure;

FIG. 8 is a cross-section view of FIG. 7 along line C-C; and

FIG. 9 is a cross-section view of FIG. 7 along line D-D.

In the drawings, the same components are indicated with the same reference signs. The figures are not drawn in accordance with an actual scale.

### DETAILED DESCRIPTION OF THE EMBODIMENTS

The present disclosure will be further explained in conjunction with the accompanying drawings.

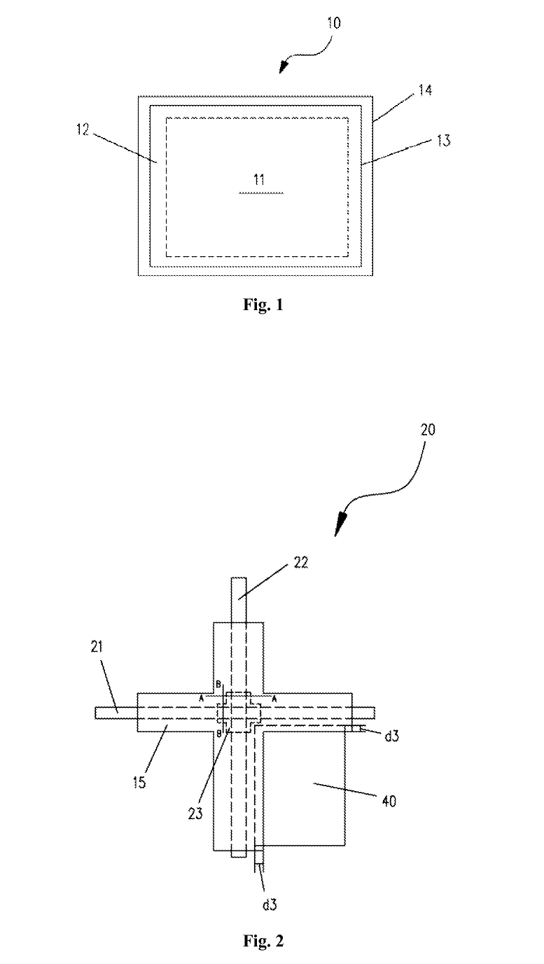

FIG. 1 schematically shows a cell body 10 of a liquid crystal display according to the present disclosure in a front view. The cell body 10 is formed by fitting a first substrate 13 and an opposite second substrate 14 together, and is filled with liquid crystals therein to form a liquid crystal cell. An area of the cell body 10 which accommodates liquid crystals forms a display area 11 for displaying a picture, and a periphery of the display area 11 forms an assembly area 12 used for assembling the first substrate 13 and the second substrate 14. The first substrate 13 and the second substrate 14 can be respectively selected as a color filter substrate and an array substrate, which are both well known in the art, and therefore will not be repeated herein.

After being fit together, the first substrate 13 and the second substrate 14 may be easily disclosed with respect to each other due to relative movement therebetween under impact of external forces. This dislocation would deteriorate quality of a liquid crystal display, and even render the liquid crystal display completely scrapped. In order to protect the first substrate 13 and the second substrate 14 against dislocation, a first nest portion 20 can be arranged in the display area 11, and a second nest portion 30 can be arranged in the assembly area 12. The first nest portion 20 and the second nest portion 30 will be depicted in detail in the following.

FIG. 2 schematically shows the structure of the first nest portion 20. The first nest portion 20 comprises a convex gate line region 21 and a convex data line region 22 that are formed on the second substrate 14, and a first recess 23 that is formed on the first substrate 13 and can be matched with the gate line region 21 and the data line region 22. After the first substrate 13 and the second substrate 14 are fit together, both of the gate line region 21 and the data line region 22 would be engaged with the first recess 23, so as to prevent relative movement between the first substrate 13 and the second substrate 14. In addition, since an existing liquid crystal display already has the convex gate line region 21 and the convex data line region 22, it is only necessary to further provide the first recess 23 on the first substrate 13, which reduces influences imposed upon aperture ratio of pixels, and meanwhile decreases production costs of the liquid crystal display.

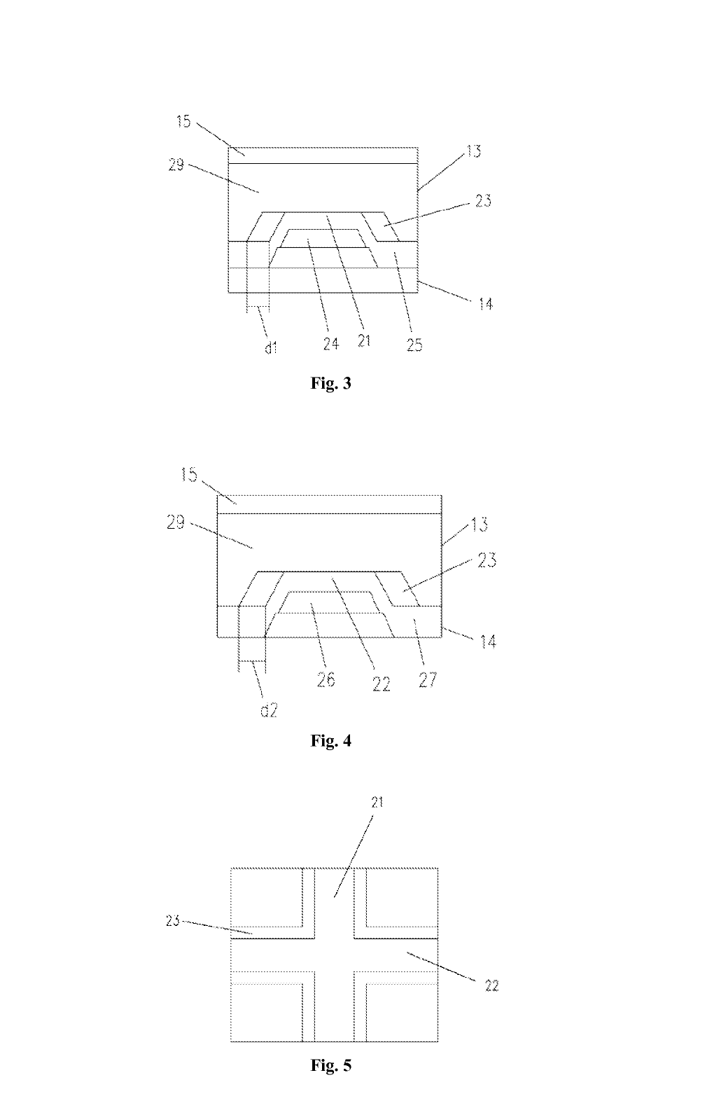

As shown in FIGS. 3 and 4, the first substrate 13 is in the form of a color filter substrate, and the first recess 23 can be arranged in a spacer 29 of the color filter substrate. It should be understood that the first recess 23 can be formed in a color barrier layer (not shown) also. The second substrate 14 is in the form of an array substrate. The gate line region 21 comprises a gate line 24 and a gate line protective layer 25 covering the gate line 24. And the data line region 22 comprises a data line 26 and a data line protective layer 27 covering the data line 26. Hence, the gate line region 21 has a projection height that can be adjusted through adjustment of thickness of the gate line 24 and that of the gate line protective layer 25, and the data line region 22 has a projection height that can be adjusted through adjustment of thickness of the data line 26 and that of the data line protective layer 27. Thus, suitable gate line region 21 and data line region 22 can be manufactured according to specific conditions of the first substrate 13 and the second substrate 14.

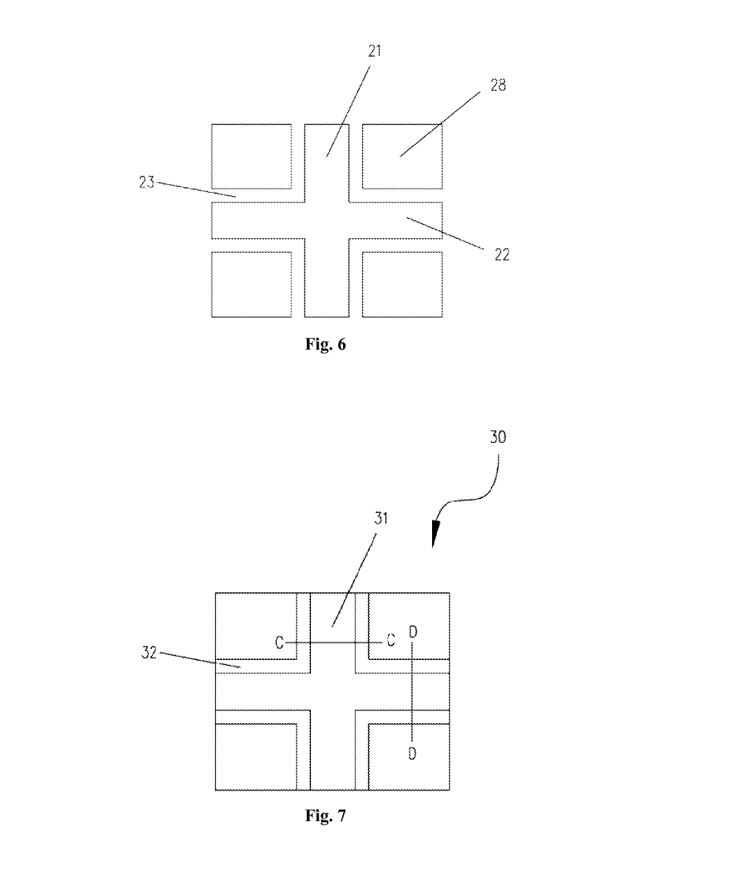

As FIG. 2 or FIG. 5 illustrates, the gate line region 21 and the data line region 22 intersect with each other and form a cross shape. The first recess 23 is provided at the intersection, and is configured as a cross-like recess that can be matched with the above cross shape. Such being the case, the gate line region 21 and the data line region 22 are imbedded into the first recess 23 and contact a bottom of the first recess 23. The first recess 23 can also be in the form of a blocking structure comprising a plurality of convex blocks 28, as FIG. 6 shows. Under this circumstance, the gate line region 21, the data line region 22, and the convex blocks 28 form a nesting island. The first nest portion 20 in such a cross shape can impede relative movement between the first substrate 13 and the second substrate 14 both laterally and longitudinally, thereby further improving yield of the liquid crystal display. In addition, in an existing liquid crystal display, the gate line region 21 and the data line region 22 have already form an intersection shape, such as a cross. Through arranging the first recess 23 at the intersection, it is unnecessary to enable the gate line region 21 and the data line region 22 to be intersected with each other, thus reducing both design difficulty and production costs.

As FIG. 2 further shows, the array substrate 14 is provided with a pixel electrode 40, and a color filter substrate 13 is provided with a black matrix 15. In a normal state, the black matrix 15 would cover an edge of the pixel electrode 40 and form a coverage region 41. The first nest portion 20 can be configured in such a manner that a size d1 of an interval formed between the gate region 21 and a side wall of the first recess 23 is smaller than a size d3 of the coverage region 41, and a size d2 of an interval formed between the data line region 22 and a side wall of the first recess 23 is also smaller than the size d3 of the coverage region 41. Thus, even if d1 and d2 are both non-zero, which may cause movement of the array substrate 14, the black matrix 15 would still maintain coverage of the edge of the pixel electrode 40. As a result, the black matrix 15 would not be subject to inadequate shading, nor would it be subject to the problem of light leakage at an edge thereof in a dark state, thereby improving quality of the liquid crystal display.

FIG. 7 schematically shows the structure of a second nest portion 30 according to the present disclosure. The second nest portion 30 comprises a convex structure 31 formed on one of the first substrate 13 and the second substrate 14, and a second recess 32 that can be matched with the convex structure 31 and is formed on the other of the first substrate 13 and the second substrate 14. After the first substrate 13 and the second substrate 14 are fit together, the convex structure 31 and the second recess 32 would engage with each other, so as to prevent relative movement between the first substrate 13 and the second substrate 14. Moreover, the convex structure 31 can be further configured to have a width smaller than that of the second recess. Thus, even if the first substrate 13 and/or the second substrate 14 may somehow bend, the wider second recess 32 can compensate the position of the convex structure 31, so as to facilitate the assembly thereof.

The convex structure 31 can be in the shape of a cross, a strip, a circle, or the letter T. In one preferred embodiment, the convex structure 31 is in the form of a cross, as shown in FIG. 7. The shape of the second recess 32 can be matched with the shape of the cross convex structure 31. It should be understood that the second recess 32 can also be in the form as shown in FIG. 5 or FIG. 6, and will not be repeatedly described herein.

The second nest portion 30 is located in the assembly area 12, and therefore will not affect displaying of the liquid crystal display. As such, the second nest portion 30 can be configured as being thicker than the first nest portion 20, so as to prevent relative movement between the first substrate 13 and the second substrate 14 more effectively.

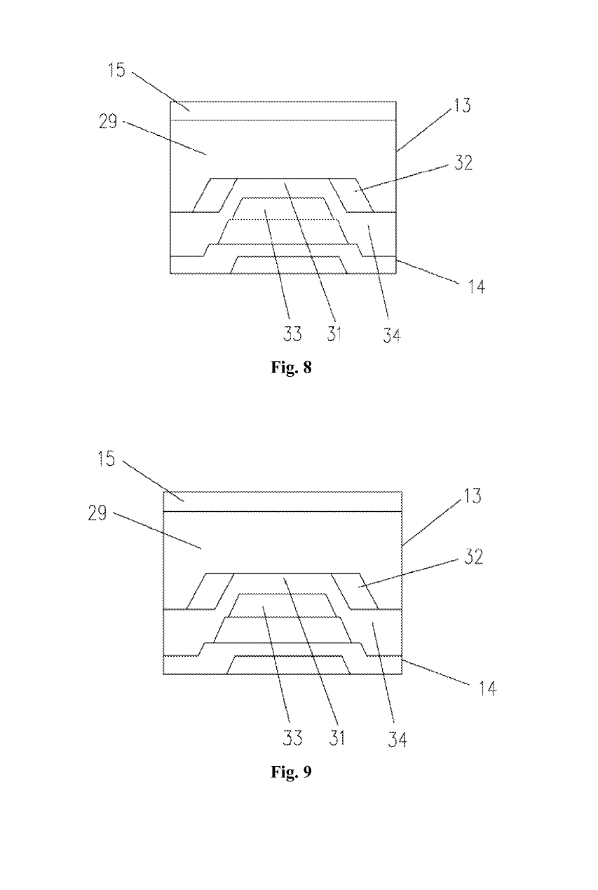

As FIGS. 8 and 9 depict, the first substrate 13 is in the form of a color filter substrate, and the second recess 32 can be arranged in the spacer 29 of the color filter substrate. It should be understood that the second recess 32 can also be formed in the color barrier layer (not shown). The second substrate 14 is in the form of an array substrate, and the convex structure 31 comprises a metal layer 33 and a metal protective layer 34 that covers the metal layer 33. Thus, the convex structure 31 would have a projection height that can be adjusted through adjustment of thickness of the metal layer 33 and that of the metal protective layer 34, so that a proper projection height thereof can be formed. The metal layer 33, of course, can further cover other layers thereunder, such as an amorphous silicon layer, a gate insulation layer, an additional metal layer, etc., which are all well known by those skilled in the art.

Although the present disclosure has been described with reference to preferred embodiments, various modifications and variants to the present disclosure may be made by anyone skilled in the art, without departing from the scope and spirit of the present disclosure. In particular, as long as there is no structural conflict, various embodiments as well as the respective technical features mentioned herein may be combined with one another in any manner. The present disclosure is not limited to the specific embodiments disclosed herein, but rather includes all the technical solutions falling within the scope of the claims.

1. A liquid crystal display, comprising a cell body which includes a first substrate and an opposite second substrate and is used for accommodating liquid crystals, an area of the cell body which accommodates liquid crystals forming a display area, and a periphery of the display area forming an assembly area,
wherein in the display area, the second substrate has a surface which faces the first substrate and is provided with a convex gate line region and a convex data line region, and the first substrate has a surface which faces the second substrate and is provided with a first recess that can be matched with the gate line region and the data line region, and
wherein when the first substrate and the second substrate fit together, the gate line region and the data line region engage with the first recess to form a first nest portion, so as to prevent relative movement between the first substrate and the second substrate.

2. The liquid crystal display according to claim 1, wherein the gate line region and the data line region intersect with each other, and the first recess is provided at an intersection of the gate line region and the data line region and matches a shape of the intersection.

3. The liquid crystal display according to claim 1, wherein the first substrate is in the form of a color filter substrate and the second substrate is in the form of an array substrate,
wherein the gate line region comprises a gate line and a gate line protective layer covering the gate line, and the data line region comprises a data line and a data line protective layer covering the data line, and
wherein the gate line region has a projection height that can be adjusted through adjustment of thickness of the gate line and that of the gate line protective layer, and the data line region has a projection height that can be adjusted through adjustment of thickness of the data line and that of the data line protective layer.

4. The liquid crystal display according to claim 2, wherein the first substrate is in the form of a color filter substrate and the second substrate is in the form of an array substrate,
wherein the gate line region comprises a gate line and a gate line protective layer covering the gate line, and the data line region comprises a data line and a data line protective layer covering the data line, and
wherein the gate line region has a projection height that can be adjusted through adjustment of thickness of the gate line and that of the gate line protective layer, and the data line region has a projection height that can be adjusted through adjustment of thickness of the data line and that of the data line protective layer.

5. The liquid crystal display according to claim 4, wherein the first recess is provided in a spacer or a color barrier layer of the color filter substrate.

6. The liquid crystal display according to claim 5, wherein the array substrate is provided with a pixel electrode thereon, and the color filter substrate is provided with a black matrix that covers a part of the pixel electrode and forms a coverage region thereon, and
wherein an interval formed between the gate line region and a side wall of the first recess has a smaller size than the coverage region, and an interval formed between the data line region and a side wall of the first recess has a smaller size than the coverage region also.

7. The liquid crystal display according to claim 1, wherein in the assembly area, one of the first substrate and the second substrate is provided with a convex structure, and the other of the first substrate and the second substrate is provided with a second recess that can be matched with the convex structure,
wherein when the first substrate and the second substrate fit together, the convex structure and the second recess engage with each other to form a second nest portion, so as to prevent relative movement between the first substrate and the second substrate.

8. The liquid crystal display according to claim 7, wherein the first substrate is in the form of a color filter substrate and the second substrate is in the form of an array substrate, and
wherein the convex structure comprises a metal layer and a metal protective layer that covers the metal layer, and has a projection height that can be adjusted through adjustment of thickness of the metal layer and that of the metal protective layer.

9. The liquid crystal display according to claim 8, wherein the second recess is provided in the spacer or in the color barrier layer of the color filter substrate.

10. The liquid crystal display according to claim 9, wherein the convex structure is in the shape of a cross, a strip, a circle, or the letter T, and the second recess matches the convex structure in shape.

11. The liquid crystal display according to claim 7, wherein the convex structure has a size smaller than the second recess.

12. The liquid crystal display according to claim 11, wherein the first substrate is in the form of a color filter substrate and the second substrate is in the form of an array substrate, and
wherein the convex structure comprises a metal layer and a metal protective layer that covers the metal layer, and has a projection height that can be adjusted through adjustment of thickness of the metal layer and that of the metal protective layer.

13. The liquid crystal display according to claim 12, wherein the second recess is provided in the spacer or in the color barrier layer of the color filter substrate.

14. The liquid crystal display according to claim 13, wherein the convex structure is in the shape of a cross, a strip, a circle, or the letter T, and the second recess matches the convex structure in shape.

15. The liquid crystal display according to claim 14, wherein the convex structure is in the shape of a cross, and the second recess matches the convex structure.
